(19) United States
(12) Patent Application Publication
(10) Pub. No.: US 2017/0159890 A1
(43) Pub. Date: Jun. 8, 2017

(54) MULTI-TECHNOLOGY OPTICAL ILLUMINATION

(71) Applicant: Concorde International, Plymouth, MN (US)

(72) Inventors: John Titus Marlow, West Saint Paul, MN (US); Jason Joseph Steigauf, Champlin, MN (US)

(73) Assignee: Concorde International, Plymouth, MN (US)

(21) Appl. No.: 14/554,003

(22) Filed: Nov. 25, 2014

Related U.S. Application Data
(60) Provisional application No. 61/908,482, filed on Nov. 25, 2013.

(51) Int. Cl. F21S 8/10

(52) U.S. Cl. CPC F21K 9/237

(57) ABSTRACT

A systems and apparatus for providing a multiple technology optical illumination device are described. According to various embodiments, a light bar housing multiple high output LEDs along with LED COB (Chip-On-Board) modules and driver circuitry is disclosed. The LED COB modules fill in space between and/or around the high output LEDs in order to provide a complete visually illuminated light bar, reduce cost and power consumption and also provide multiple illumination pattern and intensity choices.

### RELATED APPLICATIONS

This application claims priority to U.S. Provisional Application Ser. No. 61/908,482 entitled “LED Light Bar” filed on Nov. 25, 2013.

### FIELD

The present inventive subject matter relates generally to the field of auxiliary lighting, and more specifically to optical illumination using multiple technologies.

### BACKGROUND

LED light bars are the popular choice for vehicle lighting, boat lighting, as well as interior lighting. Currently the market is full of light bars that comprise of an array of high wattage LEDs. These LEDs typically range from 1 W to 25 W, with the output performance increasing with the increased wattage.

LED light bars in the market contain a varying array of spot, flood, and euro lenses or reflectors to achieve the desired output combination as required by the customer. Flood for close range illumination, spot for long range illumination, and euro for mid-range illumination. LEDs are packaged tightly together to obtain an optimal lighting performance in a small package.

Few LED light bars in the market are dimmable or come with a dimmable function.

There is a need for lights that can offer the functionality of both flood and spot, illuminating both close proximity and long distances. The goal is to produce a light of this performance with the least amount of cost possible. Often, consumers have to purchase two different lights for close-range and long-range illumination. Standard known LED light bars offer spot, euro, and flood lenses, however costs increase and efficiency suffers because they use the same LEDs. The market needs a light that can provide both functions efficiently at a reduced cost.

### DESCRIPTION OF THE DRAWINGS

FIG. 1A is a front view of a complete construction of the light according to various embodiments.

FIG. 1B is a top view of the complete construction of a light according to various embodiments.

FIG. 1C is a side view of the complete construction of a light according to various embodiments.

FIG. 1D is an isometric view of the complete construction of a light according to various embodiments.

FIG. 2 is a view of a circuit board with multiple LED types and their respective reflector/lenses according to various embodiments.

FIG. 3 is a view of an LED Chip(s) on Board (COB) module assembled to the circuit board that holds the high intensity LED and driver devices according to various embodiments.

FIG. 4 is a view of an LED COB module positioned next to the circuit board that holds the high intensity LED and driver devices according to various embodiments.

FIG. 5A-5G are views of example high and low intensity light array arrangements according to various embodiments.

### DETAILED DESCRIPTION OF THE INVENTION

Various embodiments of the inventive subject matter relate to vehicles, snowmobiles, all terrain vehicles (ATV), utility terrain vehicles (UTV), personal watercraft, motorcycles, construction equipment, marine vehicles, cars, and trucks and buildings that have a need for auxiliary lighting and a location to mount lighting.

In some embodiments, a LED bar for a vehicle or building application that may contain one or more of the following components: a) a linear or cast housing that makes up a length, b) a pair of end caps sealing the ends of the linear housing c) a bracket that can be mounted at any length of the housing, d) a lens or reflector or combination lens and reflector, d) a LED on a printed circuit board, e) a COB LED module, f) a lens, g) a set of grommets or seals to keep dust and water out of the inside of the light assembly, and h) a harness exiting the light to accept supplied power.

The inventive subject matter offers an affordable way to have LED lighting across the full length of a light bar helping ensure substantial light output across the full length of the bar but without the cost impact of using all high intensity LEDs. This arrangement also aids in lighting performance. The high intensity LEDs are utilized for longer cast light and the printed LED COB are utilized for shorter, flood light cast. In addition the bar could be wired so a user may choose to illuminate only the high intensity LEDs or only the LED COB (or combinations thereof) for selective lighting scenarios like driving near a road where you do not want to use the high intensity lights to shine oncoming traffic, or alternatively, using only the flood LED COB modules for lighting up a work area with less power consumption.

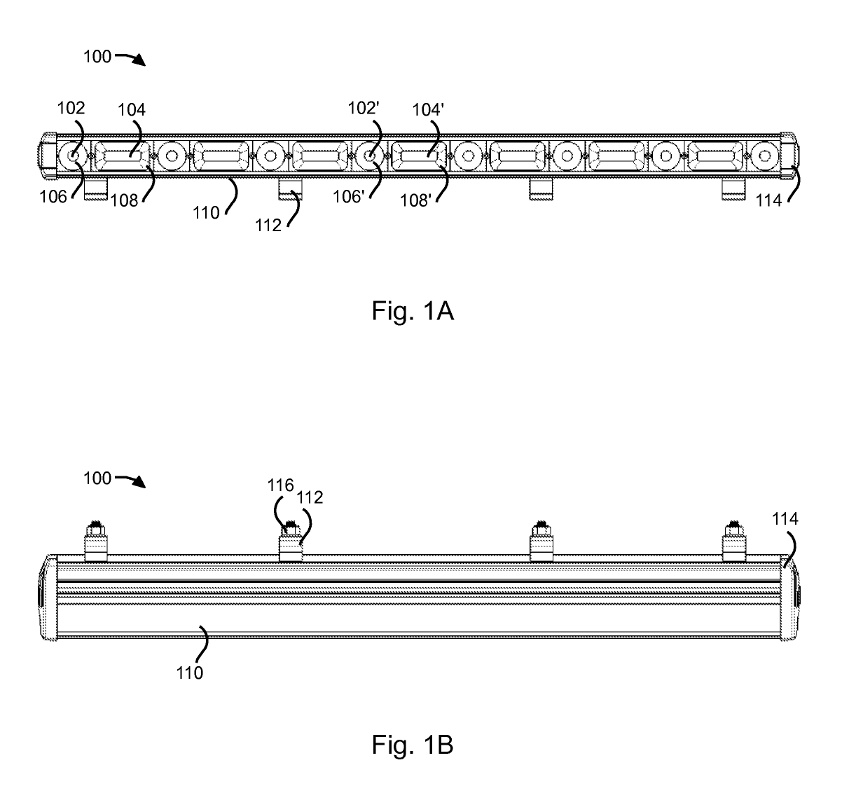

Referring to FIGS. 1A-1D the overall construction of an example embodiment can be seen. FIG. 1A is a front view of a complete construction of a light bar 100 according to various embodiments. The light bar 100 includes high intensity lights 102, low intensity lights 104, high intensity light reflectors 106, low intensity light reflectors 108, a housing 110, mounts 112 with mounting hardware 116, and end caps 114. The end caps 114 connected to the housing 110 shown is shown as a cast piece, however this could be produced by injection molding, stamped plate, etc. depending on the complexity of the shape.

The high intensity lights 102 may be arranged in various ways within/along the housing 110. Additional high intensity lights 102′ with respective reflectors 106′ may be provided as well. According to various embodiments, high intensity illumination means the use of a high power LED for maximum light output. Example devices include surface mount LED chips. According to various other embodiments, a high intensity light may also utilize a high wattage halogen or HID bulb. According to yet other embodiments, a blue laser focused on a yellow phosphorous may be used as a high intensity light source for the high intensity light 102.

The low intensity lights 104 may be arranged in various ways within/along the housing 110. The arrangement of the low intensity lights 104 may be adjacent to the high intensity lights 102. According to various embodiments, low intensity illumination means lower output LEDs such as low power LEDs or COB modules (chip on board). COB modules involve printing several small LEDs directly onto a board, then potting over the chips with a transparent substrate that can be colored to change the output color of the LED. According to additional embodiments, low intensity illumination may include low wattage halogen bulbs, cfl, lightways or similar technology.

Various embodiments of the present teachings provide for a LED light bar 100 that combines the flood performance and look of a low intensity light 104 using LED COB module with the higher output performance of a high intensity light 102 using high intensity LEDs, while keeping manufacturing and piece price low. The lower cost LED COB module fills the space between high intensity LEDs, and provides the additional benefit of close range performance. By filling this space between high intensity LEDs, the high intensity LEDs may be spaced in such a manner as to reduce the number of high intensity LEDs in a given light bar 100. Additionally, the used of LED COB modules in the space between the high intensity LEDs allows the light bar to maintain an appearance of full illumination when in use.

According to various embodiments, the inventive subject matter allows light bars to be offered at greater sizes (and shapes) for less cost to the customer. The construction also offers the opportunity to illuminate the lower intensity LED COB modules independently from the high intensity LED (or combinations of the two), giving the operator greater range of application. Additionally, LED COB modules may be provided in various colors (through the coloration of the transparent potting material) without the need to use different color lenses in the light bar 100. This allows for a single light bar 100 to not only provide differing intensities of illumination, but also differing colors. This is beneficial because the color/wavelength of the emitted light can be more or less useful in various driving/weather conditions (i.e. yellow lights for fog).

According to various embodiments, the light bar 100 may be provided in several different arrangement patterns of high and low intensity illumination. Alternating high and low intensity; low intensity illumination on the ends and high intensity illumination in the middle; high intensity illumination in the middle and low intensity illumination on the ends; two low intensity illumination lights for every single high intensity light; low intensity illumination on a lower row of lights with high intensity illumination on an upper row of lights; low intensity illumination surrounding the high intensity illumination. The lights 102,104 and reflectors 106,108 could be made so many different configurations are easily fit together. For example single reflector/lenses for each LED and each COB module allow for many different patterns of high intensity and low intensity lights to be assembled in the same housing.

According to various embodiments, the combination of high intensity lights 102 and low intensity lights 104 may provide dimming functionality. The ability to dim a light is important when approaching oncoming vehicles, persons, etc. This could be accomplished by potentiometer or other electronic control. According to various embodiments, the light bar 100 allows for dimming only the high intensity illumination while maintaining the low intensity illumination at full power, thus reducing the glare with oncoming vehicles. Another available embodiment includes a 3-position switch; off, low intensity illumination on, and all illumination on.

According to various embodiments of the inventive subject matter, low intensity illumination is used to provide a light pipe effect on a light bar. An example of this effect would arranged by mounting an LED COB module inside the light housing 110. A semi-transparent material such as polycarbonate could be used to transfer the light from the COB module to the front face of the light bar, providing a fiber optic effect. The shape may be changed to provide illumination in specific locations on the light bar 100. Examples include providing a ring of light around the high intensity lights 102 or a signature shape on the end caps 114. One way to accomplish this effect is by overmolding clear and colored material so when the light is off the light source is not seen, but when the light is on the illumination travels through the clear or semi-transparent (light transmissive) material.

According to various embodiments, the combination of lighting technology is used to provide directional lighting. Directional lighting can be important on vehicles. According to various embodiments of the inventive subject matter, directional lighting is achieved by having multiple angled surfaces on the housing 110, and mounting the high intensity light 102 and the low intensity light 104 on these angled surfaces to create one light that illuminates all desired areas without the need of multiple separate light bars mounted at different angles on a vehicle, facing different directions.

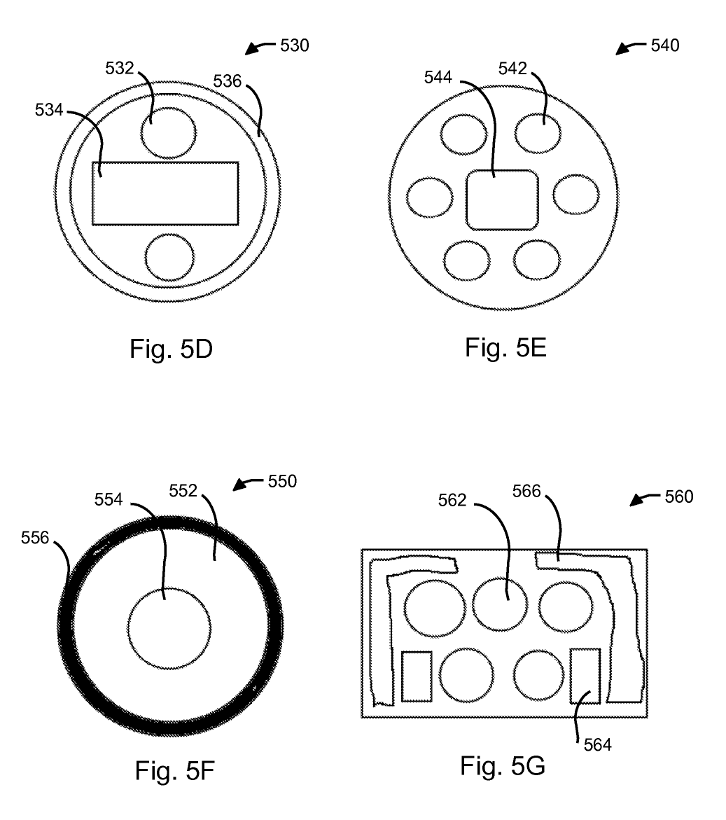

Various embodiments of the inventive subject matter provide a beneficial arrangement of the array of high intensity lights 102 and low intensity lights 104 by creating a long light with good performance and good visual illumination for the consumer without having either the cost of all high intensity illumination or the poor performance of all low intensity illumination. In some applications it may be beneficial to have close range lighting, in which case, the light bar 100 is provided with additional low intensity lights 104. In some applications long distance illumination is more important, in which case, fewer close range low intensity lights 104 versus the high intensity lights 102 are used in the light bar 100. Additional arrangements or patterns are provided in FIGS. 5A-5G to show alternate embodiments. The design, however, need not be limited to these arrangements. Different shapes (circle, rectangle . . . ) are used to identify the different example illumination types and arrangements (high and low intensity) in the example light assemblies.

Assembly and cost is benefited by combining low and high intensity illumination. The same length or size light can be produced, as a high intensity light, at a fraction of the cost. One reason for this is less high intensity illumination is used due to the use of low intensity illumination. In addition, in the case of LEDs, using less high intensity LEDs means less heat dissipation is necessary. The LED COB modules produce less heat, combined with fewer high intensity LEDs the housing can have less heat dissipating fins or less material needed to transfer the heat away from the LED. Less material means less cost. In addition, the optics for LED COB modules is less involved as they are used primarily as a flood light or signature (styling) light.

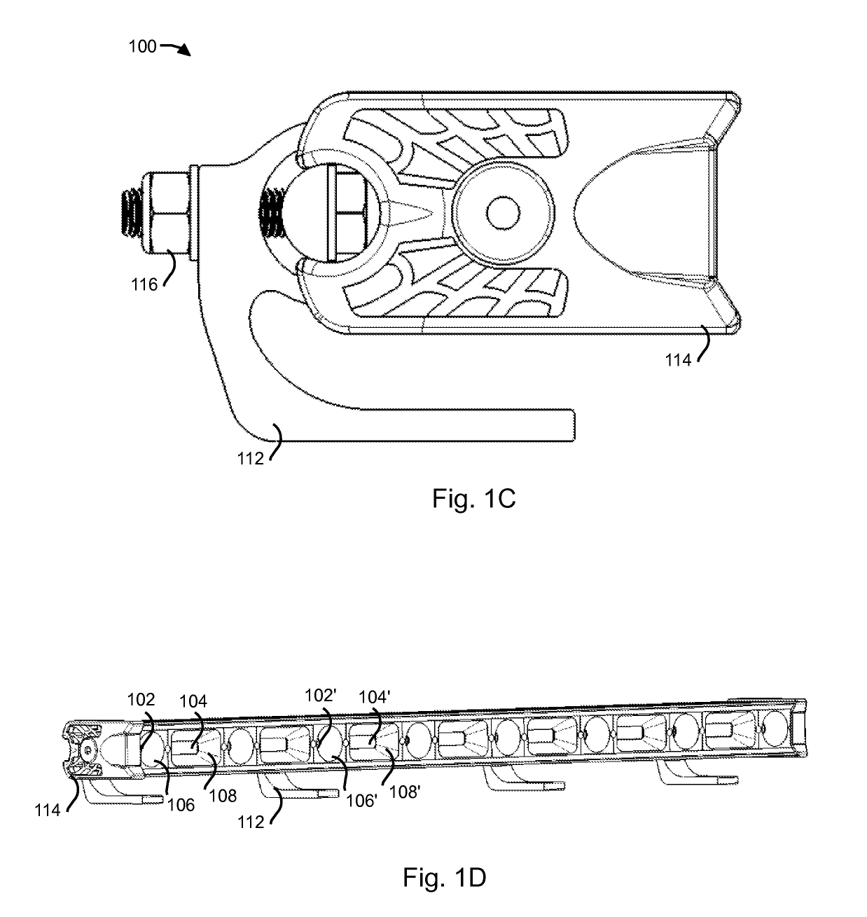

FIG. 2 is a view of a circuit board based light module 200 with multiple LED types and their respective reflector/lenses according to various embodiments. The light module 200 includes a high intensity LED 202, a COB LED 204, a first reflector 206, a second reflector 208, a casing 210, a central mounting point 212 and perimeter mounting points 214.

According to various embodiments of the inventive subject matter, the light module uses the high intensity LED 202 to provide long range illumination, while utilizing the COB LED 204 to provide flood or close range illumination. The high intensity LED 202 and the COB LED 204 may be used at the same time or separately depending on the user/manufacturer preference. The high intensity LED 202 may be provided on a separate circuit board from the COB LED 204. A central mounting point 212 and perimeter mounting points 214 are used to position and secure the lights (202, 204) within the light module 100. These mounting points may provide security through the use of fasteners. Additionally, the first reflector 206 and the second reflector 208 are arranged and secured by the casing 210 with respect to the high intensity LED 202 and the COB LED 204 via the mounting points (212, 214). The first reflector 212 is shaped to fit the high intensity LED 202, while the second reflector is shaped to fit the COB LED 204. According to various embodiments, either or both of the first reflector 212 and the second reflector 214 may be omitted. According to some example embodiments, the first reflector 212 is used with the high intensity LED 202, while the COB LED 204 is used without a reflector. The perimeter mounting points 214 allow the light module 200 to be combined with additional light modules to enable various light bar arrangements. The perimeter mounting points 214 are shown on the right and left sides of the light module 200, but they may be present in the top and bottom as well. According to yet other embodiments, the perimeter mounting points 214 may comprise other mechanisms for connecting devices, such as click-lock mechanisms, magnets, or other interlocking mechanical arrangements. The ends of the light module 200 may also include electrical connections to allow for easy connection between modules. According to some embodiments, wiring may be present to connect high intensity LEDs to other high intensity LEDs, and COB LEDs to COB LEDs, allowing for consistent control of varying illumination technologies.

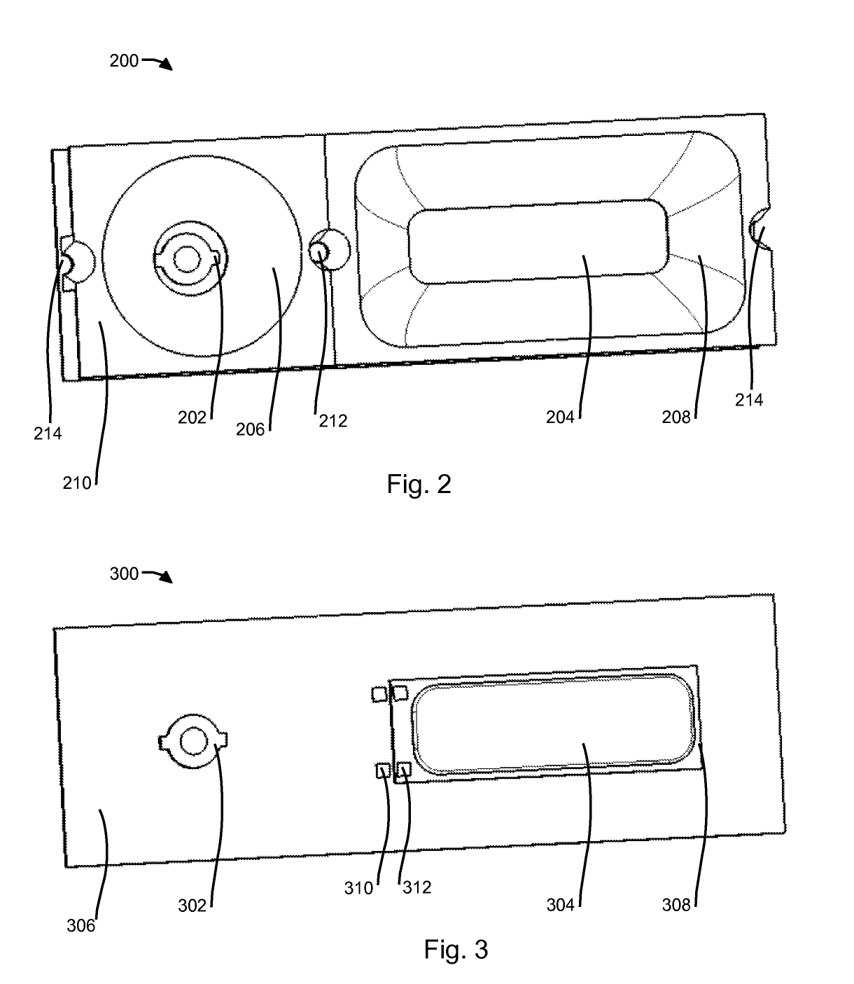

FIG. 3 is a view of an illumination board 300 having an LED COB module 304 assembled to a circuit board 306 that holds a high intensity LED 302 and driver (not shown) according to various embodiments. The illumination board 300 includes a high intensity LED 302, a LED COB module 304, a main circuit board 306, a LED COB board 308, main circuit board contacts 310, and LED COB board contacts 312. The high intensity LED 302 is mounted to a circuit board that contains other circuitry like driving circuits and electronic components for making electrical connections with power, ground, control, other illumination modules and the like. The LED COB module 304 is provided on its own circuit board 308. The LED COB board 308 is mounted to the main circuit board 306, and electrical contact is made between the main circuit board contacts 310 and the LED COB board contacts. This electrical contact may utilize wire or ribbon jumpers, solder, or other intermediary material. According to some embodiments, the main circuit board contacts 310 may be arranged to align with the LED COB board contacts 312, allowing the LED COB board 308 to be placed directly on top of the main circuit board contacts 310. In this way, an intermediary material may not be needed. If solder balls are used on the contacts, they may be simply heated to reflow and secure the connection.

According to various embodiments, multiple LED COB modules 304 with their respective LED COB boards 308 may be present on the main circuit board. The arrangement of the LED COB modules 304 with respect to the high intensity LED 302 may vary according to the needed function, light output and thermal characteristics of the illumination board 300. Similarly, multiple high intensity LEDs 302 may be used as well.

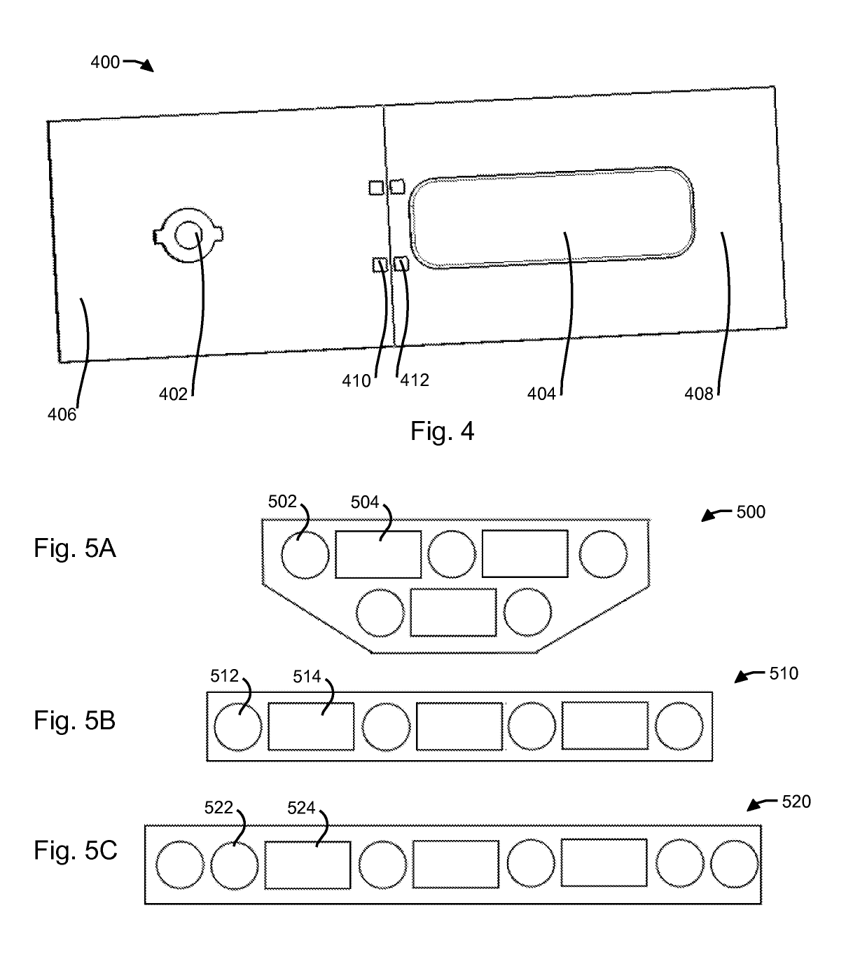

According to various embodiments of the inventive subject matter, FIG. 4 shows a view of an illumination device 400 comprising an LED COB module 404 positioned next to a high intensity LED circuit board 406 that holds a high intensity LED 402. The illumination device 400 includes the high intensity LED 402 mounted on a high intensity LED circuit board 406, the LED COB module 404, the LED COB board 408, high intensity board contacts 410 and LED COB board contacts 412. According to some embodiments, driver circuitry may be present on the high intensity LED circuit board 406. According to some other embodiments, driver circuitry may be present on the LED COB board. Driver circuitry may include one or more discrete drivers and supplemental components in electrical communication to be used to drive the high intensity LED 402 and the LED COB module 404.

Rather than mounting the LED COB module 404 and its LED COB board 408 directly on the circuit board containing a high intensity LED 402, the LED COB board 408 is provided separately and arranged adjacent to the high intensity LED circuit board 406. High intensity board contacts 410 and LED COB board contacts 412 may be electrically connected using wire or ribbon jumpers, or other conductive device. According to alternative embodiments, the contacts may be arranged such that electrical contact is made by placing the high intensity LED circuit board 406 next to the LED COB board 408. In this way, the contacts may be present on the edge of the boards, or the boards may be designed or arranged is such a way as to create a partial overlap, allowing the high intensity board contacts 410 and LED COB board contacts 412 to touch.

According to various embodiments of the inventive subject matter, an illumination device may be provided with a high intensity LED mounted on a board containing driver circuitry as well as an LED COB module (directly on that board).

FIG. 5A-5G are views of example light bars including high and low intensity light array arrangements according to various embodiments.

Referring to FIG. 5A, light bar 500 includes a horizontal and vertical arrangement of high intensity lights 502 (represented by circles) and low intensity lights 504 (represented by rectangles).

Referring to FIG. 5B, light bar 510 includes an alternating horizontal arrangement of high intensity lights 512 (represented by circles) and low intensity lights 514 (represented by rectangles).

Referring to FIG. 5C, light bar 520 includes a horizontal arrangement of high intensity lights 522 (represented by circles) and low intensity lights 524 (represented by rectangles). In this arrangement, additional high intensity lights 522 are provided on the outer edges for enhanced distance illumination.

Referring to FIG. 5D, light pod 530 includes an arrangement of high intensity lights 532 (represented by circles) and low intensity lights 534 (represented by rectangles). In addition, a second low intensity light source 536 is provided as a halo about the light pod 530. The second low intensity light source 536 may be a LED COB module or other low intensity lighting element, or it may be an optical lightway (semi-transparent polycarbonate for example) illuminated from behind by a light source. The halo light should provide visually continuous illumination about the lighting elements that it surrounds.

Referring to FIG. 5E, light pod 540 includes an arrangement of high intensity lights 542 (represented by circles) and low intensity lights 544 (represented by rectangles). In this arrangement, the high intensity lights 542 encircle the low intensity light 544. The reverse arrangement is considered as well with low intensity lights 544 encircling a high intensity light 542.

Referring to FIG. 5F, light pod 550 includes a high intensity light 552, a low intensity light 554 encircling the high intensity light 552 and an outer ring 556. According to some embodiments, the high intensity light 552 and the low intensity light 554 are substantially coplanar. According to other embodiments, the low intensity light 554 may be arranged behind the high intensity light 552. In this way, the low intensity light 554 may be provided on a first circuit board mounted within the light pod 550, and the high intensity light may be offset (vertically looking down at the figure). The offset may be arranged by using an arm extending from the edge of the light pod. The low intensity light 554 then illuminates all around the high intensity light 552. In either the coplanar or the multi-level arrangement, the low intensity light 554 is designed to provide visually continuous illumination about the high intensity light 552.

The outer ring 556 may be used to hold the arm engaging the high intensity light 552. Alternatively, the outer ring 556 may include another low intensity light or lightway. The outer ring 556 may provide differing intensity light or even differing color.

Referring to FIG. 5G, light pod 560 is provided with a vertical and horizontal arrangement of high intensity lights 562 (represented by circles) and low intensity lights 564 (represented by rectangles), with the addition of additional shaped low intensity lights 566. The additional shaped low intensity lights 566 may be utilized with the low intensity lights 564 or may be utilized separately for different illumination levels. Alternatively, the additional shaped low intensity lights 566 may provide differing colored illumination to the light bar 560. The additional shaped low intensity lights 566 may also be provided in specific shapes (such as a logo or other shape of interest) to provide an illuminated (possibly colored) display.

According to various embodiments of the inventive subject matter, an example LED based light bar comprises the following components: a housing; a pair of end caps on each end of the housing, the end caps allowing for mounting of a bracket on each end of the bar; seals on each end cap to prevent water and dust intrusion into the ends of the light bar; a cavity in the housing to hold LEDs, lenses, and reflectors; one or more high output LEDs mounted inside the housing cavity; one or more LED COB modules mounted inside the housing cavity; a lens, reflector, or lens and reflector combination for the high output LEDs; a reflector to surround the LED COB modules; a circuit board, LED driver that drives both the high output LED and the LED COB module; a grommet on the front of the linear housing; a protective lens that seals against the grommet on the front of the linear housing and; a bracket that mounts to the linear housing and allows for multiple mounting options down the length of the bar as well as rotation.

Thus, example embodiments of the inventive subject matter are disclosed. One skilled in the art will appreciate that the present teachings can be practiced with embodiments other than those disclosed. High intensity LEDs are used as an exemplary lighting source, but it is considered that other high intensity or spot beam lighting may be used as well. Similarly, LED COB modules are used as an exemplary lighting source, but it is considered that other lower intensity, flood, or other low-cost lighting source may be used as well. The disclosed embodiments are presented for purposes of illustration and not limitation, and the present teachings are limited only by the claims that follow.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A light assembly comprising:
a housing having a front and rear;
a high intensity LED mounted within the housing;
an LED COB module shaped to surround the high intensity LED, providing visually continuous illumination about the high intensity LED; and
driver circuitry in electrical communication with the high intensity LED and the LED COB module to regulate current supplied to the high intensity LED and the LED COB module.

2. The light assembly of claim 1, further comprising a light transmissive lightway, wherein the LED COB module is set behind the lightway, allowing the lightway to carry light from the LED COB to the front of the housing.

3. The light assembly of claim 1, wherein the LED COB module and the high intensity LED are controlled independently, allowing for selective low intensity and high intensity illumination.

4. The light assembly of claim 1, further comprising a circuit board, wherein the high intensity LED and the driver circuitry are mounted on the circuit board.

5. The light assembly of claim 4, wherein the LED COB module is mounted on the circuit board.

6. The light assembly of claim 4, further comprising a second circuit board, wherein the LED COB is mounted to the second circuit board.

7. The light assembly of claim 6, wherein the second circuit board is in electrical communication with the first circuit board.

8. The light assembly of claim 1, wherein the LED COB module comprises an array of discrete LED COB devices.

9. A light module comprising:
a circuit board;
a high intensity LED attached to the circuit board;
a LED COB module attached to the circuit board adjacent to the high intensity LED;
driver circuitry attached to the circuit board in electrical communication with the high intensity LED and the LED COB module;

10. The light module of claim 9, wherein the LED COB module is mounted directly on the circuit board.

11. The light module of claim 9, wherein the LED COB module includes a LED COB board, the LED COB board providing the mechanical and electrical connections between the LED COB module and the circuit board.

12. A light bar comprising:
a housing having a length and a height;
a high output LED mounted inside the housing;
an LED COB module mounted inside the housing cavity adjacent to the high output LED;
a driver operable to drive the high output LED and the LED COB module;

13. The light bar of claim 12, wherein the LED COB module comprises an array of discrete LED COB lights.

14. The light bar of claim 12, further comprising one or more additional high output LEDs and one or more additional LED COB modules, the additional high output LEDs and the additional LED COB modules arranged in an array over two axis defined by the length of the housing and the height of the housing.

15. The light bar of claim 12, wherein the high output LED and the LED COB module are mounted at two different angles within the housing.

16. The light bar of claim 12, wherein the LED COB module is set behind a light transmissive material to direct light from the LED COB module.

17. The light bar of claim 12, wherein the LED COB module and the high output LED are controlled independently with switches.

18. The light bar of claim 12, wherein the LED COB module and the high output LED are controlled independently with a dimmer, wherein the dimming function selectively illuminates the LED COB module, the high output LED or both.

19. The light bar of claim 14, wherein the array includes alternating additional LED COB modules and additional high output LEDs within the housing.

20. The light bar of claim 12, wherein, when illuminated, the arrangement of the LED COB module and the high output LED provide a full visual illumination across the length and height of the housing.
